(19) United States
(12) Patent Application Publication
(10) Pub. No.: US 2003/0038454 A1
(43) Pub. Date: Feb. 27, 2003

(54) Fifth wheel attachment for trailer hitches

(76) Inventor: Antonio J. Valencia, West Palm Beach, FL (US)

Correspondence Address: HENDERSON & STURM LLP, 1301 PENNSYLVANIA AVENUE, N.W., SUITE 1020, WASHINGTON, DC, 20004-1707, US

(21) Appl. No.: 09/885,333

(22) Filed: Aug. 23, 2001

(51) Int. Cl. B60D 1/00

(52) U.S. Cl. 280/511; 280/433

(57) ABSTRACT

A fifth wheel arrangement (10) for raising the rear end of an SUV (100) wherein the arrangement (10) includes a tow bar member (20) adapted to be received in the towing package receptacle (101) and forming a support platform for a wheel suspension unit (12) that includes a wheel (42) connected by a pair of torsion arms (36) and (40) to a horizontal (37) and a vertical (30) support column wherein the vertical support column is provided with a jack shaft (34) that can be actuated by a selected height adjustment unit (13) (14) for varying the position of the wheel (42) relative to the tow bar member (20).

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of auxiliary wheel assemblies for vehicles in general and in particular to a fifth wheel attachment that is specifically designed for use with the conventional trailer hitch arrangement found on most sports utility vehicles.

2. Description of Related Art

As can be seen by reference to the following U.S. Pat. Nos. 4,522,420; 4,886,294; 4,772,037; and, 4,671,535, the prior art is replete with myriad and diverse auxiliary wheel attachments for different types of vehicles.

While all of the aforementioned prior art constructions are more than adequate for the basic purpose and function for which they have been specifically designed, they are uniformly deficient with respect to their failure to provide a simple, efficient, and practical auxiliary wheel attachment that is specifically designed for use in combination with the conventional towing package that is standard equipment on most sports utility vehicles (SUVs) to raise the rear end of an overloaded carrying capacity of the vehicle. It should be noted that none of the prior art references is intended to increase the tongue weight of a towing package by raising the rear end of the towing vehicle to compensate for an overloaded condition.

As a consequence of the foregoing situation, there has existed a longstanding need among SUV owners for a new and improved fifth wheel arrangement that can be accommodated by a standard towing package receptacle to elevate the rear end of an SUV and increase the transport and/or towing capacity of the SUV and the provision of such an arrangement is the stated objective of the present invention.

### BRIEF SUMMARY OF THE INVENTION

Briefly stated, the fifth wheel arrangement for SUVs that forms the basis of the present invention comprises in general a hitch attachment unit, a wheel suspension unit, a pair of height adjustment units, and a towing accessory unit; wherein, the height adjustment units can be selectively employed to raise and lower the fifth wheel relative to the hitch attachment unit and the towing accessory unit allows the hitch attachment unit to be employed for its intended function and purpose.

As will be explained in greater detail further on in the specification, the hitch attachment unit comprises a tow bar member that is dimensioned to be operatively engaged in the receptacle of the towing package that is standard equipment on most SUVs wherein the tow bar member forms a support platform for the wheel suspension unit.

The wheel suspension unit comprises in general a pair of torsion arms that is operatively connected to both a vertical and a horizontal support column to suspend the fifth wheel beneath the tow bar member; wherein, the vertical support column is fixedly secured to the tow bar member and contains a jack shaft that is vertically displaceable relative to the vertical support column under the influence of a selected one of the height adjustment units.

In addition, the towing accessory package is adapted to be secured to a mounting plate element fixedly secured to the vertical support column and bearing a releasably conventional hitch connector such as a ball hitch so that the towing bar member can perform its intended purpose and function.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a side elevation view of an overloaded SUV not equipped with the auxiliary wheel arrangement that forms the basis of the present invention;

FIG. 2 is a side elevation view of the SUV of FIG. 1 equipped with the auxiliary wheel arrangement that forms the basis of this invention;

FIG. 3 is a side elevation view showing the auxiliary wheel arrangement provided with a manual crank member, a ball hitch attachment, and a brake light;

FIG. 4 is a side elevation view showing the auxiliary wheel arrangement provided with a motorized crank member and a brake light;

FIG. 5 is an exploded perspective view of the fifth wheel attachment device and the towing attachment;

FIG. 6 is a cross-sectional view taken through line 6-6 of FIG. 5;

FIG. 7 is a cross-sectional view taken through line 7-7 of FIG. 5;

FIG. 8 is a top plan view showing the position of the fifth wheel arrangement during a left hand turn of the SUV;

FIG. 9 is a top plan view showing the position of the fifth wheel arrangement during a right hand turn of the SUV; and,

FIG. 10 is a side elevation view of the fifth wheel arrangement with all of the accessory attachments installed thereon.

### DETAILED DESCRIPTION OF THE INVENTION

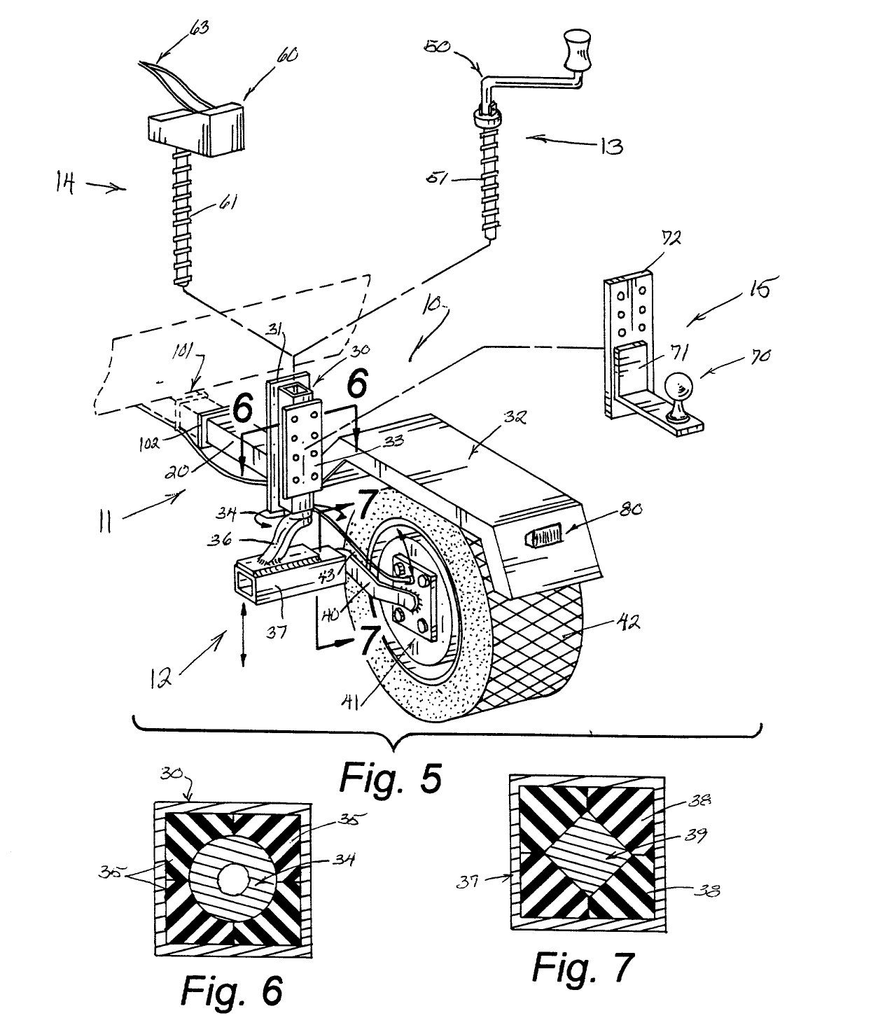

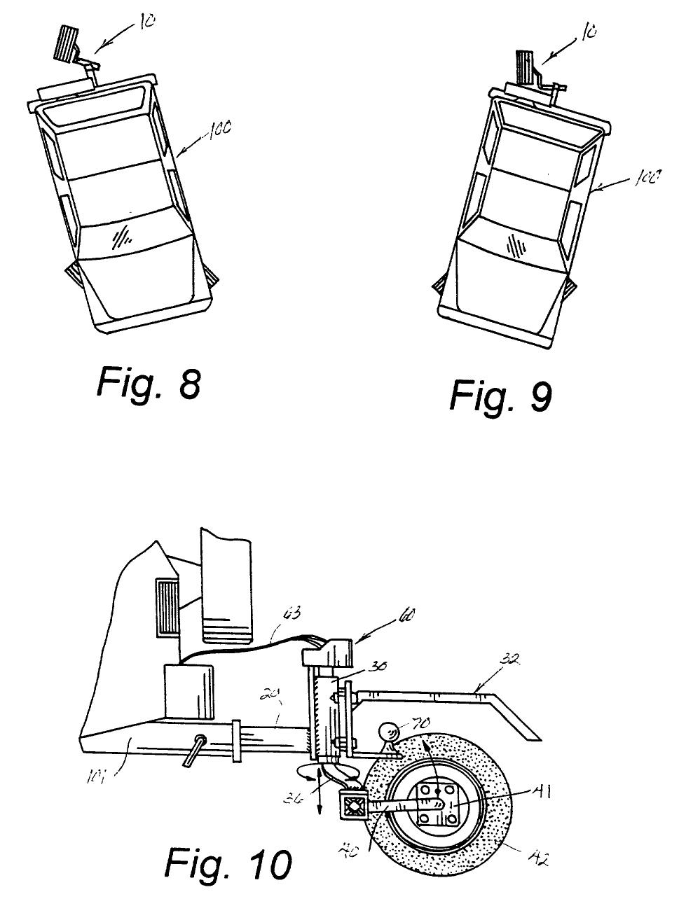

As can be seen by reference to the drawings, and in particularly to FIG. 2, the fifth wheel arrangement that forms the basis of the present invention is designated generally by the reference number 10. Turning now to FIG. 5, it can be seen that the fifth wheel arrangement 10 comprises in general a hitch attachment unit 11, a suspension wheel unit 12 and a pair of optional height adjustment units 13 14 and a towing accessory unit 15 that are adapted to be received by the wheel suspension unit 12. These units will now be described in seriatim fashion.

As can best be seen by reference to FIGS. 5 and 10, the hitch attachment unit 11 comprises an elongated hollow rectangular tow bar member 20 having one end that is dimensioned to be received in the conventional tow bar receptacle 102 that is part of the towing package 101 that is standard equipment on most sports utility vehicles 100; wherein, the other end of the tow bar member 20 is provided with the wheel suspension unit 12.

The wheel suspension unit 12 comprises in general a vertical support column 30 having a rear face fixedly secured to a vertical mounting plate 31 that is in turn fixedly secured to the outboard end of the tow bar member 20. In addition, one side of the vertical support column 30 is provided with a fender element 32 that is tangentially affixed thereto, and the front face of the vertical support column member 30 is provided with an apertured accessory mounting plate element 33 whose purpose and function will be described in greater detail further on in the specification.

As can best be appreciated by reference to FIGS. 5 through 7, the upper end of the vertical support column 30 is provided with a conventional threaded jack shaft 34 that may be raised and lowered relative to the interior of the vertical support column member 30 in a well recognized fashion; wherein, the jack shaft 34 is surrounded by a first plurality of resilient torsion inserts 35 that frictionally engage the periphery of the jack shaft 34 to resist the torsional displacement of the jack shaft 34 relative to the vertical support column.

In addition, the lower end of the jack shaft 34 is provided with a first torsion arm 36 that extends downwardly and outwardly relative to the vertical support column 30; wherein, the lower end of the first torsion arm 36 is fixedly secured to a hollow horizontal support column 37.

The horizontal support column 37 is in turn provided with a second plurality of resilient torsion inserts 38 that are dimensioned to frictionally engage the shaft 39 of a second laterally extending torsion arm 40 whose purpose and function will be described presently.

As can best be seen by reference to FIG. 5, the outboard end of the second torsion arm 40 is fixedly secured to a hub assembly 41 which rotatably supports a wheel 42 having an electric brake line connection 43 wherein the wheel 42 may be raised and lowered relative to the ground and the fender element 32 via the jack shaft 34 as will be described next.

Still referring to FIG. 5, it can be seen that the first optional height adjustment unit 13 comprises a manual crank member 50 having a threaded stem 51 that is adapted to engage the hollow jack shaft 34 to raise and lower the jack shaft 34 within the vertical support column 30 for the purpose of raising and lowering the wheel 42 relative to the tow bar member 20.

The second optional height adjustment unit 14 comprises a motorized crank member 60 having a threaded shaft 61 adapted to engage the hollow jack shaft 34 to raise and lower the wheel 42 relative to the tow bar member 20; wherein, the motorized crank member 60 may be provided with electrical leads 63 connected to a remote switch 64 for actuating the motorized crank member 60 from within the SUV as depicted in FIG. 4.

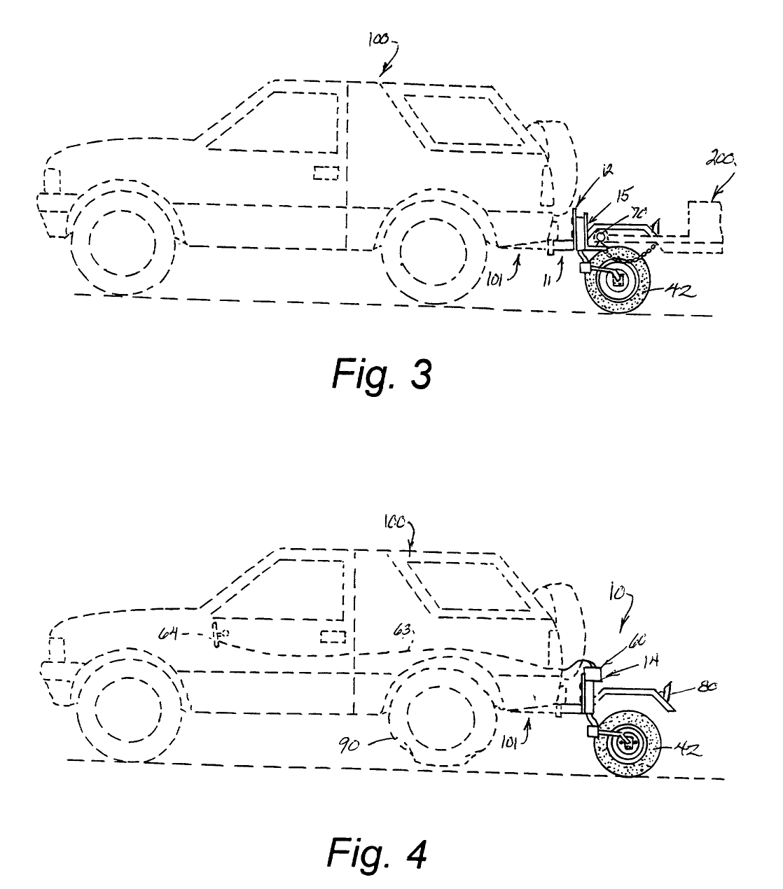

As can also be seen by reference to FIGS. 3 and 5, the towing accessory unit 15 comprises a standard ball hitch 70 mounted on an L-shaped bracket 71 that is affixed to an apertured mounting plate adapter element 72 which is adapted to be secured at different heights on the mounting plate element 33 so that the tow bar member 20 can be employed in the normal fashion to pull a trailer 200.

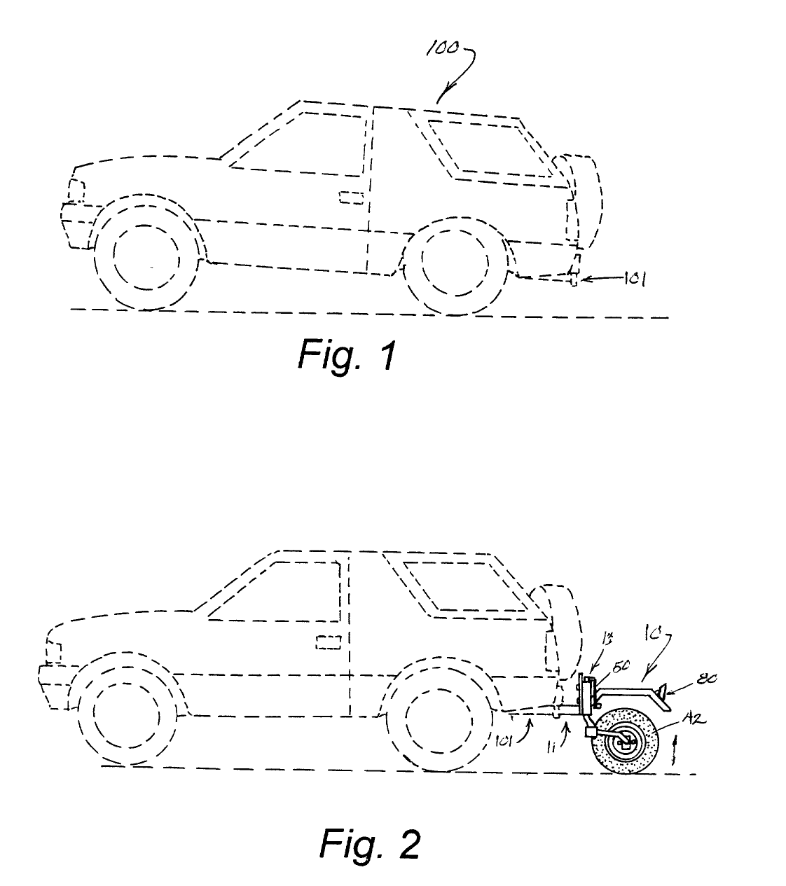

Referring now to FIGS. 1 through 4, it can be seen that the initial purpose of this invention was to offset the overloading of the rear end of an SUV as depicted in FIG. 1. As shown in FIGS. 2 and 4, the rear end of the SUV can be raised up by the fifth wheel arrangement using either the manual 50 or motorized 60 crank members to compensate for the overloaded condition of the SUV or to compensate for a flat tire 90 without the need to change the tire immediately. Furthermore, once the fifth wheel arrangement 10 has been installed and raised to the desired height by either one of the optional height adjustment units 13 and 14, the towing accessory unit 15 can be installed to allow the tow bar member 20 to function in its normal fashion. In addition, the optional height adjustment units 13 and 14 can be employed to raise up the wheel 43 to a storage position.

As can also be seen by reference to FIGS. 3 through 5, this invention also contemplates the provision of a brake light arrangement 80 on the rear fender element 32 wherein the brake light 80 is electrically coupled to the towing vehicle 100 in a well recognized fashion.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

In the claims, means-plus-function clauses are intended to cover the structures described herein as performing the recited function and not only structural equivalents, but also equivalent structures.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A fifth wheel arrangement for a sports utility vehicle having a towing package provided with a tow bar receptacle wherein the fifth wheel arrangement comprises:
a hitch attachment unit including a tow bar member having a first end adapted to be releasably received in said tow bar receptacle and having a second end
a wheel suspension unit operatively connected to said second end of the tow bar member and including a wheel operatively associated with a vertical support column; and,
means for varying the height of the wheel member relative to said vertical support column.

2. The arrangement as in claim 1; wherein, said wheel suspension unit includes a first torsion arm operatively disposed intermediate said wheel and said vertical support column.

3. The arrangement as in claim 2; wherein, said wheel suspension unit further comprises:
a threaded jack shaft that is vertically disposable within said vertical support column and has an upper end and a lower end.

4. The arrangement as in claim 3; wherein, the upper end of the jack shaft is adapted to receive the threaded stem of a crank shaft member.

5. The arrangement as in claim 4; wherein, said crank shaft member is manually operated.

6. The arrangement as in claim 4; wherein, said crank shaft member is motorized.

7. The arrangement as in claim 5; wherein, the wheel suspension unit further comprises
a horizontal support column operatively connected to said vertical support column by said first torsion arm; and,
a second torsion arm operatively connected between said horizontal support column and said wheel.

8. The arrangement as in claim 7; wherein, said wheel suspension unit further comprises
a first plurality of resilient torsion inserts disposed within the vertical support column in a surrounding relationship relative to a portion of said first torsion arm; and,
a second plurality of resilient torsion inserts disposed within said horizontal support column in a surrounding relationship relative to a portion of said second torsion arm.

9. The arrangement as in claim 1; wherein, the wheel suspension unit further includes a fender element operatively connected to said vertical support column and disposed in an over lying relationship to at least a portion of said wheel.

10. The arrangement as in claim 1; wherein, the wheel suspension unit further includes an apertured mounting plated element fixedly secured to said vertical support column.

11. The arrangement as in claim 10; further comprising
a towing accessory unit including an apertured mounting plate adapter element operatively associated with a mounting plate element and provided with a ball hitch.

12. The arrangement as in claim 6; wherein, the wheel suspension unit further comprises
a horizontal support column operatively connected to said vertical support column by said first torsion arm; and,
a second torsion arm operatively connected between said horizontal support column and said wheel.

12. The arrangement as in claim 12; wherein, said wheel suspension unit further comprises
a first plurality of resilient torsion inserts disposed within the vertical support column in a surrounding relationship relative to a portion of said first torsion arm; and,
a second plurality of resilient torsion inserts disposed within said horizontal support column in a surrounding relationship relative to a portion of said second torsion arm.
